(19) United States
(12) Patent Application Publication
(10) Pub. No.: US 2009/0052901 A1
(43) Pub. Date: Feb. 26, 2009

(54) HYBRID FIBER COAX (HFC) CIRCUIT

(75) Inventor: Floyd Derek Cagle, Opelika, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KNOLOGY, INC., West Point, GA (US)

(21) Appl. No.: 11/841,444

(22) Filed: Aug. 20, 2007

(51) Int. Cl. H04B 10/00

(52) U.S. Cl. 398/116

(57) ABSTRACT

A hybrid fiber coax (HFC) circuit comprises a diplexer and laser. The diplexer has an input terminal receiving a downstream radio-frequency (RF) signal from a passive optical network (PON). The diplexer outputs this signal from its common terminal onto a cable distribution network (CDN) covering the “last mile” to the customer. The diplexer receives on the common terminal an upstream radio-frequency (RF) signal from the CDN which it outputs on its output terminal. The laser connects to receive the upstream RF signal from the output terminal and uses this signal to generate an optical upstream RF signal transmitted to the head-end or hub via the PON. The HFC circuit can also comprise an RF amplifier, equalizer, or pod adjustment unit. Elements of the HFC circuit can be mounted on a substrate with an interface connection configured to fit into an optical network terminal (ONT). A related system is also disclosed.

### BACKGROUND OF THE INVENTION

Increasingly, users are demanding broadband service from their communication and media service providers. Broadband service includes telephone, Internet access, and cable television provided to users over a single distribution network which may be composed of cable, optical fiber or wireless media. To provide broadband service, fiber-to-the-curb (FTTC) networks are now relatively common. FTTC networks provide distribution of communication signals over passive optical networks (PONs) from a head-end or hub to neighborhood pedestals. From the pedestals onward to the houses or buildings (sometimes called the “last mile”), distribution in FTTC networks is performed using existing cable or wire line networks. Although fiber-to-the-home (FTTH) is advantageous in providing broadband connectivity in some service areas, typically in areas with newer housing or building construction, service providers who have invested heavily in cable network build-outs are reluctant to replace the cable with fiber to convert to an FTTH network until their investments in infrastructure have been sufficiently profitable to justify further capital expenditure to enhance network bandwidth. Nonetheless, to stay competitive and responsive to user demand, FTTC service providers must be able to provide broadband service to their users or risk losing market share to competitors. Unlike broadcast services such as cable television, broadband service consumes considerable bandwidth on the upstream path from the home or building to the service provider's head-end or hub. The nature of broadband permits the customer to use telephones, controls, computers, and other devices to generate and transmit voice, data and richer sets of commands in the upstream direction via their set-top boxes or cable modems. This relatively large upstream signal flow is contrary to the basic assumptions under which many cable networks were originally designed, namely, that communication signal flow would be largely unidirectional and broadcast from the head-end to the users' equipment. Now, with services like enhanced menus, pay-per-view, interactive TV, games and other enhancements, upstream bandwidth requirements are much greater in broadband services than had been the case in previous cable television networks.

Further complicating matters is the fact that different FTTC networks use different communication protocols. At the physical layer, the protocol used on the FTTC network can be quadrature phase shift-keyed (QPSK) modulation, quadrature amplitude modulation (QAM) or other protocol. It would be desirable to provide the ability to enhance upstream bandwidth for broadband service without having to significantly change passive optical network (PON) and “last mile” cable distribution network (CDN) investments in a manner that is agnostic to the communication protocols used at the physical layer on the PON and CDN.

### SUMMARY OF THE INVENTION

The present invention, in its various embodiments, overcomes the problem indicated above. In one embodiment, a hybrid fiber coax (HFC) circuit of the invention enables a service provider to convert an optical network terminal (ONT) used in an FTTC network into one providing greater bandwidth on its upstream side without the need to significantly change the “last mile” cable distribution network (CDN) with higher bandwidth media.

An apparatus in accordance with a general embodiment of the invention is a HFC circuit comprising a diplexer and a laser. The diplexer is configured with first and output terminals coupled to a common terminal. The diplexer is connected to receive a downstream radio-frequency (RF) signal at the input terminal, and to output the downstream RF signal on the common terminal. The diplexer is further connected to receive an upstream RF signal on the common terminal, and to output the upstream RF signal on the output terminal. The laser is coupled to receive the upstream RF signal from the diplexer's output terminal, and generates an optical upstream RF signal based on the electrical upstream RF signal. The laser output is connected to an upstream optical fiber that is different from the downstream optical fiber, leading to doubling of the upstream bandwidth through use of the HFC circuit. Advantageously, the HFC circuit enables one to adapt an ONT of an FTTC network to permit broadband service through enhancement of upstream optical signal bandwidth using the physical layer protocol that is native to the FTTC network.

In other more specific embodiments, in addition to the diplexer and laser, the downstream RF signal has a modulation frequency in a first frequency band and the upstream RF signal has a modulation frequency within a second frequency band that is different from the first frequency band. The diplexer can be configured with a filter to separate the upstream RF signal from the downstream RF signal on the common terminal to output the upstream RF signal on the diplexer's output terminal. In one specific embodiment, the first frequency band of the upstream RF signal is five (5) to forty-two (42) megaHertz and the second frequency band of the downstream RF signal is from fifty (50) to eight-hundred-seventy (870) megaHertz. The laser can be a distributed feedback (DFB), Fabry-Perot or other type of laser.

In more specific embodiments, the apparatus can further comprise an RF amplifier coupled to receive and generate an amplified version of the downstream RF signal. The RF amplifier can be coupled to provide the amplified version of the downstream RF signal to the diplexer. The RF amplifier can comprise a power doubler to generate the amplified version of the downstream RF signal. The apparatus can comprise an equalizer coupled to receive the amplified version of the downstream RF signal. The equalizer adjusts the power of the amplified version of the downstream RF signal according to its frequency to generate an equalized version of the downstream RF signal. The downstream RF signal includes a plurality of distinct channel frequencies within the frequency band, and the equalizer adjusts the power of the downstream RF signal with a tilt from high to low frequency channels to compensate for frequency-dependent attenuation over a cable or line distribution network to user equipment. The apparatus can further comprise a pod adjustment coupled to receive the equalized version of the downstream signal. The pod adjustment controls power level of the downstream RF signal uniformly for all frequency channels within the frequency band so that the input to the cable distribution network can be made to be the same level despite differences in power level of the downstream RF signal received from the ONT. The pod adjustment can be configured with a set screw to permit adjustment of the power level. The apparatus can comprise a substrate, such as a printed circuit board (PCB), to support the diplexer, laser, RF amplifier, equalizer and pod adjustment. The substrate can have a connection interface for plugging into a connection slot of an optical network terminal (ONT). The interface and substrate can have electrical connections to power at least the RF amplifier and laser from electrical power provided by the ONT. The substrate can be double-slotted for heat dissipation. The apparatus can comprise a connection on the substrate to couple the input terminal of the diplexer to receive the downstream RF signal from the ONT resulting from optical-to-electrical (O/E) conversion of a downstream optical signal by the ONT. The apparatus can comprise a connection on the substrate to couple the output terminal of the diplexer to the laser to generate the upstream optical signal. Furthermore, a waveguide on the substrate can be connected to couple the upstream optical signal to an optical fiber of a passive optical network (PON) to a head-end or hub. Moreover, the apparatus can comprise a connection on the substrate to couple the common terminal of the diplexer to provide the downstream RF signal and to receive the upstream RF signal from a cable distribution network.

A system of the invention comprises a passive optical network (PON); a cable distribution network (CDN); an optical network terminal (ONT), and a reverse data laser (HFC) circuit. The ONT is coupled to the PON to receive and optical-to-electrical (O/E) convert a downstream optical RF signal from the PON to generate an electrical downstream RF signal. The HFC circuit is coupled to receive the electrical downstream RF signal from the ONT and outputs this signal to the CDN. The HFC circuit is further coupled to receive an electrical upstream RF signal from the CDN and to generate an optical upstream RF signal based on the electrical upstream RF signal. The HFC circuit is coupled to provide the optical upstream RF signal to the PON. The HFC circuit can comprise the components described above.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a hybrid fiber coax (HFC) circuit in accordance with one embodiment of the invention;

FIG. 2 is a block diagram of the HFC circuit and how it is used in an optical network terminal (ONT) connected to a passive optical network (PON) and cable distribution network (CDN) to houses and buildings; and

FIG. 3 is a block diagram of a relatively specific embodiment of the HFC circuit of the invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### 1. Definitions

‘Connected’ or ‘coupled’ refers to joining of devices or elements so that they can communicate a signal to one another either directly or through intermediate devices or elements, through electrical, optical or wireless media or connection.

‘Downstream’ refers to a position or element that is further along a signal path relative to a reference point. It can also be used to refer to the direction of travel of the signal in a direction away from a reference point toward the user equipment side of a network. For example, a signal that travels from the head-end or hub to user equipment at the end of an FTTC distribution network travels in the downstream direction.

‘Upstream’ refers to a position or element that is at a position closer to the optical receiver at the head-end or hub of a passive optical network (PON). For example, a signal that travels from user equipment to a head-end or hub of an FTTC network travels in the upstream direction.

### 2. General Embodiment of the HFC Circuit

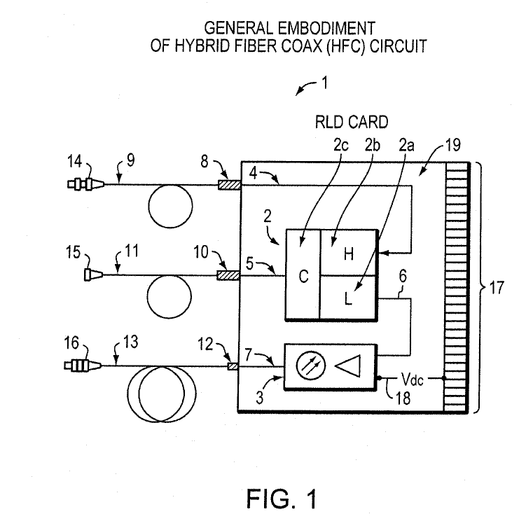

In FIG. 1 a hybrid fiber coax (HFC) circuit 1 in accordance with a relatively general embodiment of the invention comprises a diplexer 2 and a laser 3. The diplexer 2 is a commercially available device well known to those of ordinary skill in the art. The diplexer 2 is configured with a high terminal 2a and a low terminal 2b, which are connected to a common terminal 2c. The high terminal 2a is coupled via connection 4 to receive a downstream electrical radio-frequency (RF) signal resulting from optical-to-electrical (O/E) conversion of a downstream optical signal originating from a head-end or hub on the passive optical network (PON) side of the FTTC network. The high terminal 2a is configured to provide the downstream electrical RF signal to the common terminal 2c for transmission in the downstream direction via cable distribution network (CDN) to houses or buildings in the service area.

Traveling in the opposite direction, the common terminal 2c receives an electrical upstream RF signal from connection 5 via a cable distribution network (CDN) connecting to houses or buildings in the service area. The common terminal 2c is configured to provide this signal as an output on the low terminal 2b. The laser 3 is coupled via connection 6 to receive the upstream electrical RF signal from the low terminal 2b. The laser 3 uses this signal to modulate an optical carrier signal generated by the laser to produce an upstream optical signal. The laser 3 can be a distributed feedback (DFB) laser or a Fabry-Perot laser, for example. The laser 3 can be coupled to an optional optical waveguide 7 to guide the upstream optical signal to an optical fiber of the PON to guide the signal to an optical receiver in the remote cabinet, hub, or head-end of the FTTC network. Alternatively, the laser 3 can be aligned to provide the upstream optical signal to the upstream optical fiber without use of the optical waveguide 7. An intermediate optical element (not shown) such as a lens or mirror may be used to guide the upstream optical signal from the output of laser 3 to the input of an optical fiber.

The HFC circuit 1 of FIG. 1 also comprises a coupler 8 which couples connection 4 to an optical network terminal (ONT) to cable 9 to receive an optical-to-electrical (O/E) signal generated by the ONT from a downstream optical signal originating at the head-end or hub of the FTTC network. The HFC circuit 1 further comprises a coupler 10 which couples the connection 5 to mini coaxial cable (CATV 5, for example) 11 to receive the upstream RF signal from set top boxes or cable modems in houses or buildings. The HFC circuit 1 also has a coupler 12 such as an optical fiber splice to optically couple the laser 3 to provide the upstream optical signal to an upstream element such as the optical receiver of a hub via optical fiber 13. To connect the cable 9 to an ONT, the cable 9 has a standard connector 14. The cable 11 can be provided with a standard connected 15 to connect to the CDN. The optical fiber 13 can be fitted with standard connector 16 to enable it to be connected to the PON for transmission of the upstream optical signal to the remote cabinet, hub, or head-end.

To receive electric power for the laser 3, the HFC circuit 1 comprises a connection interface 17. In this embodiment, the connection interface 17 is advantageously configured to fit into and receive power from an asynchronous digital subscriber line (ADSL) connection slot of the ONT. Thus, the HFC circuit 1 requires no reconfiguration of the ONT in order to be used with such unit. The minus five (−5) volt direct current (DC) power supply is coupled through connection interface 17 to the laser 3 via connection 18 to generate the upstream optical signal with sufficient power to permit its detection at the hub's optical receiver.

The HFC circuit 1 comprises a substrate 19 to support the diplexer 2 and laser 3. The substrate 19 is composed of printed circuit board (PCB) or other material and provides structural support for the diplexer 2 and 3 and associated electrical and optical connections 4, 5, 6, 7, 18 for these elements.

### 3. System and Operation of HFC Circuit

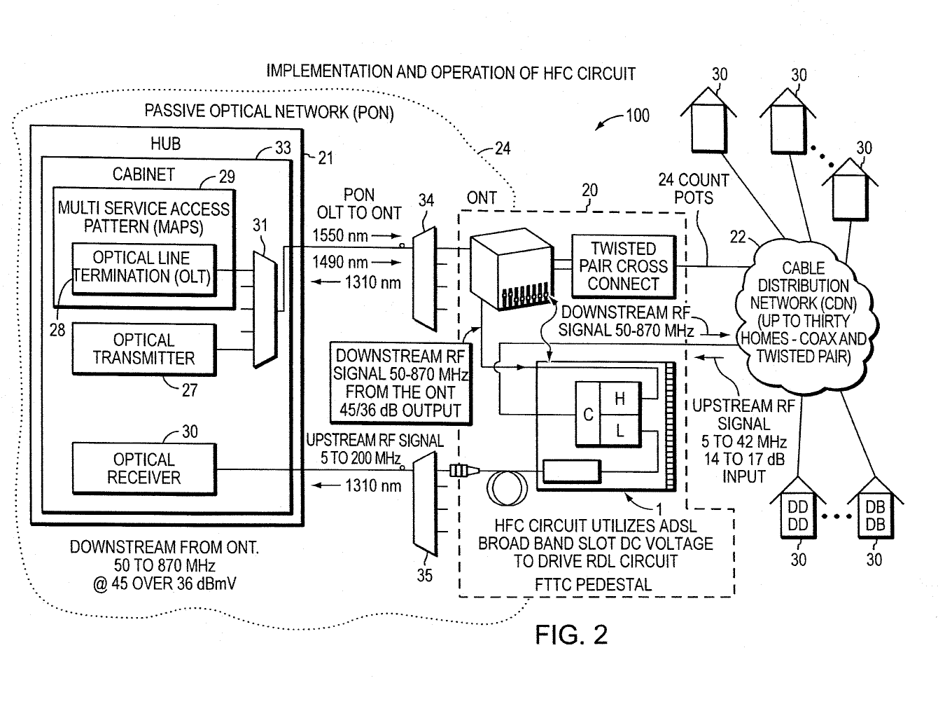

FIG. 2 generally shows a system 100 including the HFC circuit 1 of the invention. The system 100 generally comprises an ONT 20, a head-end or hub 21, and a CDN 22. The HFC circuit 1 is designed to be installed in the ONT 20 at pedestal locations in the neighborhood of the houses or buildings 30. In FIG. 2 the HFC circuit 1 is connected to an ONT 20 of the system 100 through its connection interface 17. The ONT 20 is connected to receive downstream optical RF (video) signal at a wavelength of 1550 nanometers (nm) from an optical transmitter 27 of a head-end or hub 21 in system 100. The downstream optical signal also comprises voice (plain-old-telephone-service or “POTS”) and data at a wavelength of 1490 nm generated by an optical line termination (OLT) 28. The OLT 28 is part of a multi-service access platform (MAP) 29 that multiplexes voice (plain old telephone service or “POTS”) and data at 1490 nm in the same downstream optical signal as the RF signal. Multiplexer 31 is connected to receive the optical RF signal at 1550 nm from the optical transmitter 27 and the optical voice and data signal at 1490 nm from the OLT 28, and it multiplexes these signals together to produce the downstream optical signal provided to the ONT 20 and others via splitter 34.

The ONT 20 converts the downstream RF signal at 1550 nm into an electronic RF signal that is input to the high side of the HFC circuit's diplexer 2. The HFC circuit 1 outputs the electronic RF signal on common terminal 2c for transmission to set top boxes or cable modems of houses or buildings via CDN 22 of system 100. The downstream RF signal at 1550 nm can contain multiple channels modulated at intervals from fifty (50) to eight-hundred-seventy (870) megaHertz (MHz). The downstream signal is a broadcast signal that serves up to thirty (30) houses or units of buildings 30. Signals directed upstream from the set top boxes or cable modems are received via the CDN 22 on the HFC circuit's common terminal 2c, and output from the low side terminal 2b to the laser 3 for electrical-to-optical (E/O) conversion to generate an upstream optical signal optically-modulated in a range of frequencies from five (5) to forty-two (42) MHz with one-hundred-forty-four (144) channels spaced at intervals of 0.256 kHz. The HFC circuit 1 outputs the resulting upstream optical signal to the multiplexer 35 on the PON 24 at a carrier wavelength of 1310 nm. The multiplexer 35 is capable of multiplexing the upstream optical signal with others above forty-two (42) MHz. Accordingly, the upstream optical signal may have multiple channels ranging from five (5) to two-hundred (200) MHz. The upstream optical signal is transmitted over optical fiber on the PON 24 to the hub's optical receiver 30. The hub's optical receiver 30 receives and processes the upstream optical signal in ways well known to those of ordinary skill in the art.

### 4. Specific Embodiment of the HFC Circuit

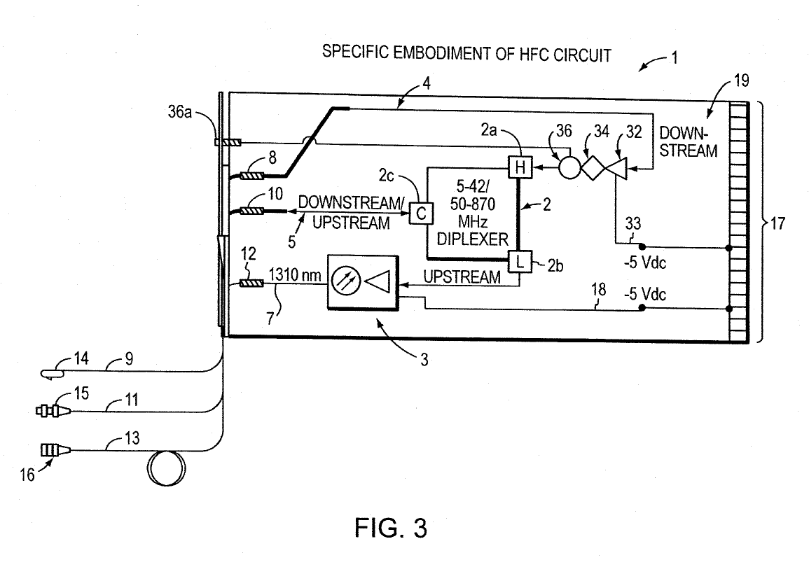

FIG. 3 is a relatively specific embodiment of the HFC circuit 1. Many of the elements of the HFC circuit 1 are identical to those of FIG. 1 and thus will not be described again with reference to FIG. 3. In addition to the elements of FIG. 1, the embodiment of the HFC circuit 1 of FIG. 3 comprises an RF amplifier 32, an equalizer 34, and a pod adjustment 36. The RF amplifier 32 can be a power doubler, for example, and serves to amplify the downstream RF signal received from the ONT 20 following O/E conversion. For example, the RF amplifier 32 can be a seven (7) watt, five-hundred-eighty milliampere (580 mA) unit powered by a minus five (−5) Volt output of the ONT 20 through connection 33 to the interface 17. The RF amplifier 32 is designed to amplify the downstream RF signal with channel frequencies ranging from 50 to 870 MHz with a hybrid gain of +44 db per channel over as many as one-hundred-thirty-five (135) channels spaced at six (6) MHz intervals.

The equalizer 34 is connected to receive the amplified version of the electrical downstream RF signal from the RF amplifier 32, and is used to tilt the power spectrum of the downstream signal to provide a gradual decrease in power from the highest to lowest frequency channel so that the highest frequency channel 870 MHz has nine (9) decibels (dB) more power than the lowest frequency channel at 50 MHz. Because transmission over a cable distribution network has the effect of attenuating higher frequency channels more than the lower frequency channels, the 9 dB tilt in power provided by the equalizer 22 enables the downstream RF signal to arrive over the CDN 22 at a set top box or cable modem in houses or buildings 30 with power that is approximately the same regaHFCess of the channel used to transmit the signal. The pod adjustment 36 receives the equalized version of the RF signal from the equalizer 34 and can be used to raise or lower the power of the downstream RF signal from zero (0) to three (3) dB uniformly across all channels. Because the downstream RF signal generated by the ONT can have input power varying from fourteen (14) to seventeen (17) dB, the pod adjustment 36 enables one to adjust input power to the diplexer 2 to a uniform seventeen (17) dB level. The pod adjustment 36 has a set screw 36a accessible on the outside of the HFC circuit 1 to enable a person to use a screw driver to set the pod adjustment 36 to obtain the desired seventeen (17) dB input power for the downstream RF signal. The pod adjustment 36 is connected to provide the adjusted downstream RF signal to the high side terminal 2a of the diplexer 2.

In the embodiment of FIG. 3 the diplexer 2 is a standard forty-two/fifty (42/50) MHz split diplexer to separate the low side channel frequencies from 5-42 MHz from the high side channel frequencies from 50-870 MHz. The HFC laser 3 is a point-five milliWatt (0.5 mW), twenty-point-eight (20.8) microampere, five (5) to forty-two (42) MHz laser with a carrier wavelength of 1310 nm.

The coupler 8 can connect to a seventy-five (75) ohm cable 9 that is in turn coupled to a connector 14. The connector 14 couples to the ONT 10's PON output from which the downstream RF signal is output following O/E conversion in the ONT. The coupler 10 connects to a seventy-five (75) ohm cable 11 to a connector 15. The connector 15 is coupled to the CDN 22 leading to the set top boxes or cable modems of houses or buildings 30. The optical coupler 12 connects to an optical fiber 13 that guides the optical upstream RF signal to standard connector 16. The connector 16 connects to the optical receiver 30 in the hub 21 via the PON 24.

In the embodiment of FIG. 3 the HFC circuit 1 has dimensions of three-and-one-half (3.5) inches by ten (10) inches. The HFC circuit 1 of FIG. 3 is configured so that it can be coupled in the ADSL slot for the ONT 20 which can an Entrisphere® T500 or T550 unit, for example. The HFC circuit 1 of FIG. 3 has a double-slotted configuration to enhance heat dissipation.

### 5. Advantages

Advantageously, the HFC circuit 1 of the present invention enables expansion of the upstream bandwidth on the optical side of an FTTC network without requiring significant change to infrastructure on either the PON or CDN side of the FTTC network apart from installation of the HFC circuit 1. Therefore, the HFC circuit 1 can be used to enable a service provider to provide more broadband service than would be otherwise possible through an existing FTTC network. In addition, the HFC circuit 1 is agnostic to the physical layer protocol used to modulate the signals on the FTTC network. The HFC circuit 1 simply transfers the downstream RF signal from the PON 24 to the CDN 22 and the upstream RF signal from the CDN 22 to the PON 24 following amplification without processing of the signals at the network protocol level. In other words, whatever the protocol of the downstream RF signal and upstream RF signal, the HFC circuit 1 transfers the signal between the PON 24 and CDN 22 in the same protocol. The HFC circuit 1 therefore avoids the complication of protocol conversion and handling and associated expense.

### 6. Alternatives

Although the foregoing is a relatively specific description of the invention, it should be understood that various modifications are possible without departing from the scope of the invention. For example, although the HFC circuit 1 has been described as using a range of frequencies from fifty (50) to eight-hundred-seventy (870) MHz for the downstream RF signal and five (5) to forty-two (42) MHz for the upstream RF signal, the HFC circuit 1 can be used with other frequency bands or channels than those specifically enumerated herein without departing from the scope of the invention. Furthermore, the substrate 8 and its connection interface 7 can be configured to be of different size or shape to enable it to be used with different ONT models.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a diplexer configured with input and output terminals coupled to a common terminal, the diplexer connected to receive a downstream radio-frequency (RF) signal at the input terminal, and connected to output the downstream RF signal on the common terminal, the diplexer further connected to receive an upstream RF signal on the common terminal, and to output the upstream RF signal on an output terminal; and
a laser coupled to receive the upstream RF signal from the diplexer's output terminal, and generating an upstream optical signal based on the upstream RF signal.

2. An apparatus as claimed in claim 1 wherein the downstream RF signal has a modulation frequency in a first frequency band and the upstream RF signal has a modulation frequency within a second frequency band different than the first frequency band, and the diplexer is configured to separate the upstream RF signal from the downstream RF signal on the common terminal to output the upstream RF signal on the output terminal.

3. An apparatus as claimed in claim 2 wherein the first frequency band is from fifty (50) to eight-hundred-seventy (870) megaHertz (MHz) and the second frequency band is from five (5) to forty-two (42) megahertz (MHz), and the diplexer is configured to separate the upstream RF signal on the second frequency band from the downstream RF signal on the first frequency band.

4. An apparatus as claimed in claim 1 wherein the laser is a distributed feedback (DFB) laser.

5. An apparatus as claimed in claim 1 wherein the laser is a Fabry-Perot laser.

6. An apparatus as claimed in claim 1 further comprising:
an RF amplifier coupled to receive and generate an amplified version of the downstream RF signal, the RF amplifier coupled to provide the amplified version of the downstream RF signal to the diplexer.

7. An apparatus as claimed in claim 6 wherein the RF amplifier comprises a power doubler to generate the amplified version of the downstream RF signal.

8. An apparatus as claimed in claim 6 further comprising:
an equalizer coupled to receive the amplified version of the downstream RF signal, the equalizer adjusting the power of the amplified version of the downstream RF signal according to its channel frequency to generate an equalized version of the downstream RF signal.

9. An apparatus as claimed in claim 8 wherein the downstream RF signal has one of a plurality of distinct channel frequencies within the frequency band, and wherein the equalizer adjusts the power of the downstream RF signal with a tilt from high to low frequency channels to compensate for frequency-dependent attenuation over a cable or line distribution network to user equipment.

10. An apparatus as claimed in claim 9 further comprising;
a pod adjustment coupled to receive the equalized version of the downstream signal, for adjusting a power level of the downstream RF signal uniformly for all frequency channels within the frequency band.

11. An apparatus as claimed in claim 10 wherein the pod adjustment has a set screw to permit adjustment of the power level.

12. An apparatus as claimed in claim 10 further comprising:
a substrate supporting the diplexer, laser, RF amplifier, equalizer and pod adjustment.

13. An apparatus as claimed in claim 11 wherein the substrate has a connection interface for plugging into a connection slot of an optical network terminal (ONT), the interface and substrate having electrical connections to power at least the RF amplifier and laser from electrical power provided by the ONT.

14. An apparatus as claimed in claim 11 wherein the substrate is printed circuit board (PCB) providing connections for the diplexer, laser, RF amplifier, equalizer and pod adjustment.

15. An apparatus as claimed in claim 11 wherein the substrate is double-slotted for heat dissipation.

16. An apparatus as claimed in claim 11 further comprising a connection on the substrate to couple the input terminal of the diplexer to receive the downstream RF signal from the ONT resulting from optical-to-electrical (O/E) conversion of a downstream optical signal by the ONT.

17. An apparatus as claimed in claim 16 further comprising a connection on the substrate to couple the output terminal of the diplexer to the laser to generate the upstream optical signal.

18. An apparatus as claimed in claim 17 further comprising a waveguide on the substrate to couple the upstream optical signal to an optical fiber of a passive optical network (PON) to a head-end or hub.

19. An apparatus as claimed in claim 18 further comprising a connection on the substrate to couple the common terminal of the diplexer to provide the downstream RF signal and to receive the upstream RF signal from a cable distribution network (CDN).

20. An apparatus as claimed in claim 1 further comprising:
a substrate supporting the diplexer and laser.

21. An apparatus as claimed in claim 20 wherein the substrate has a connection interface for plugging into a connection slot of an optical network terminal (ONT), the interface and substrate having an electrical connection to power the laser from electrical power provided by the ONT.

22. An apparatus as claimed in claim 21 wherein the substrate further supports a coupler and connection coupled to receive the downstream RF signal from the ONT after optical-to-electrical (O/E) conversion.

23. An apparatus as claimed in claim 21 wherein the substrate further supports a coupler and connection for connecting to a cable distribution network (CDN).

24. An apparatus as claimed in claim 21 wherein the substrate further supports a waveguide and coupler for connecting to an optical receiver of a passive optical network (PON).

25. An apparatus as claimed in claim 20 further comprising:
an RF amplifier supported by the substrate and coupled to receive the downstream RF signal, the RF amplifier generating an amplified version of the downstream RF signal, the RF amplifier coupled to provide the amplified version of the downstream RF signal to the diplexer.

26. An apparatus as claimed in claim 20 further comprising:
an equalizer supported by the substrate and coupled to receive the downstream RF signal and generating an equalized version of the downstream RF signal, the equalizer coupled to provide the equalized version of the downstream signal to the diplexer.

27. An apparatus as claimed in claim 20 further comprising;
a pod adjustment supported by the substrate and coupled to receive the downstream RF signal and generating an adjusted power level for the downstream RF signal uniformly for all frequency channels within the frequency band, the pod adjustment providing the downstream RF signal with adjusted power level to the diplexer.

28. A system comprising:
a passive optical network (PON);
a cable distribution network (CDN);
an optical network terminal (ONT) coupled to the PON and CDN, the ONT connected to receive and optical-to-electrical (O/E) convert a downstream optical RF signal from the PON to generate an electrical downstream RF signal; and
a hybrid fiber coax (HFC) circuit coupled to receive the electrical downstream RF signal form the ONT, the HFC circuit further coupled to receive an electrical upstream RF signal from the CDN and generating an optical upstream RF signal, the HFC circuit coupled to provide the optical upstream RF signal to the PON.

29. A system as claimed in claim 28 wherein the HFC circuit comprises a diplexer and a laser, the diplexer configured with input and output terminals coupled to a common terminal, the diplexer connected to receive the electrical downstream radio-frequency (RF) signal at the input terminal, and connected to output the electrical downstream RF signal on the common terminal, the diplexer further connected to receive the electrical upstream RF signal on the common terminal, and to output the electrical upstream RF signal on an output terminal; and the laser coupled to receive the upstream RF signal from the diplexer's output terminal, and generating an upstream optical signal based on the upstream RF signal.
